(19) United States
(12) Patent Application Publication
(10) Pub. No.: US 2007/0145743 A1
(43) Pub. Date: Jun. 28, 2007

(54) SEE-THROUGH OPTICALLY ENHANCED PUSH-TO-CONNECT COUPLING FOR INDICATION OF TUBE/CONDUIT INSERTION

(75) Inventors: Dorothy G. Greenberger, Kalamazoo, MI (US); Gregory Kreczko, Kalamazoo, MI (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(73) Assignee: PARKER-HANNIFIN CORPORATION, Cleveland, OH (US)

(21) Appl. No.: 11/610,645

(22) Filed: Dec. 14, 2006

Related U.S. Application Data
(60) Provisional application No. 60/750,323, filed on Dec. 14, 2005.
(60) Provisional application No. 60/803,413, filed on May 30, 2006.
(60) Provisional application No. 60/827,804, filed on Oct. 2, 2006.

(51) Int. Cl. F16L 21/06

(52) U.S. Cl. 285/322

(57) ABSTRACT

A push-in tube coupling that facilitates visual verification of insertion of a tube into the coupling or viewing of a medium within the coupling. The tube coupling comprises a coupling body having a cavity into which a tube can be inserted to mate with the coupling body, and a transparent or translucent lens in a wall of the coupling body for optical enhancement of an interior portion of the coupling.

### RELATED APPLICATIONS

This application claims the benefit of U.S. Provisional Application Nos. 60/750,323, filed Dec. 14, 2005, 60/803,413 filed May 30, 2006, and 60/827,804 filed Oct. 2, 2006, which applications are hereby incorporated herein by reference.

### FIELD OF THE INVENTION

The present invention relates to push-to-connect tube couplings (also referred to as push-in tube couplings or fittings) that provide a visual indication of tube insertion.

### BACKGROUND OF THE INVENTION

Push-to-connect tube couplings of various types are known in the art. To make a connection, the end of a tube is inserted into the coupling. As the tube is inserted, the end of the tube is engaged by a collet or other means that grips the tube to prevent withdrawal of the tube from the coupling. Various techniques heretofore have been employed to provide a verification that the tube has been sufficiently inserted into the coupling. One technique is to provide a mark on the outside of the tube that is spaced from the end of the tube by a distance that will align the mark with and end of the tube coupling when the tube is fully inserted into the coupling. Another technique involves the use of one or more ports in the coupling body for viewing the tube once inserted into the coupling, thereby enabling visual verification that the tube has been sufficiently pushed onto the coupling. Still another technique is to make the coupling body of a transparent material to allow at least the end of the inserted tube to be seen through the transparent body thereby to visually confirm insertion of the tube into the body.

### SUMMARY OF THE INVENTION

The present invention provides a push-in tube coupling that includes a built-in lens. The built-in lens can be located to facilitate visual verification of insertion of a tube into the coupling and/or to view a medium within the interior of the tube coupling. The built-in lens provides optical enhancement (magnification) of the area where tube insertion is verified or where the medium is to be viewed.

More particularly and according to one aspect of the invention, a tube coupling comprises a coupling body having a cavity into which a tube can be inserted to mate with the coupling body, and a transparent or translucent lens in a wall of the coupling body for optical enhancement of an interior portion of the cavity where tube insertion can be verified.

According to another aspect of the invention, a tube coupling comprises a coupling body having a cavity into which a tube can be inserted to mate with the coupling body, an interior chamber, and a transparent or translucent lens in a wall of the coupling body for optical enhancement of an interior portion of the chamber for viewing a medium within the chamber.

In one or more embodiments of the invention, the lens may have outer and inner surfaces, at least one of which is curved to optically magnify the interior portion of the cavity where tube insertion can be verified or the chamber where the medium is viewed. More particularly, the outer surface of the lens may be convex with a radius of curvature greater than the inner surface of the lens.

The coupling body may be made of a transparent material that has a portion thereof shaped to form the lens. Alternatively, the lens may be secured in an opening in the wall of the coupling body. In either case, the lens may extend annularly with respect to the cavity or chamber to provide for viewing from different angles.

In accordance with another aspect of the invention, a tube coupling includes a built-in lens for optical enhancement (magnification) of the area where tube insertion is verified.

Other objects, advantages and novel features of the invention will become apparent from the following detailed description of the invention when considered in conjunction with the drawings.

### BRIEF DESCRIPTION OF THE DRAWINGS

FIG. 1 is an elevational view of an exemplary tube coupling according to the present invention, showing one port having a tube inserted therein and another port with no tube inserted therein.

FIG. 2 is a cross-sectional view of the tube coupling of FIG. 1, also showing one port having a tube inserted therein and another port with no tube inserted therein.

FIG. 3 is a cross-sectional view of a tube coupling according to another aspect of the invention, showing opposite ports having respective tubes inserted therein and a medium, in particular a fiber optic cable bundle, extending through the tubes and tube coupling.

### DETAILED DESCRIPTION

The reference herein to “tube” or “tubes” encompasses not only tubes but other tubular members such as flexible tubing, hoses or a tubular couplings, such as a short tubular piece to which a hose, tubing or the like is or can be coupled.

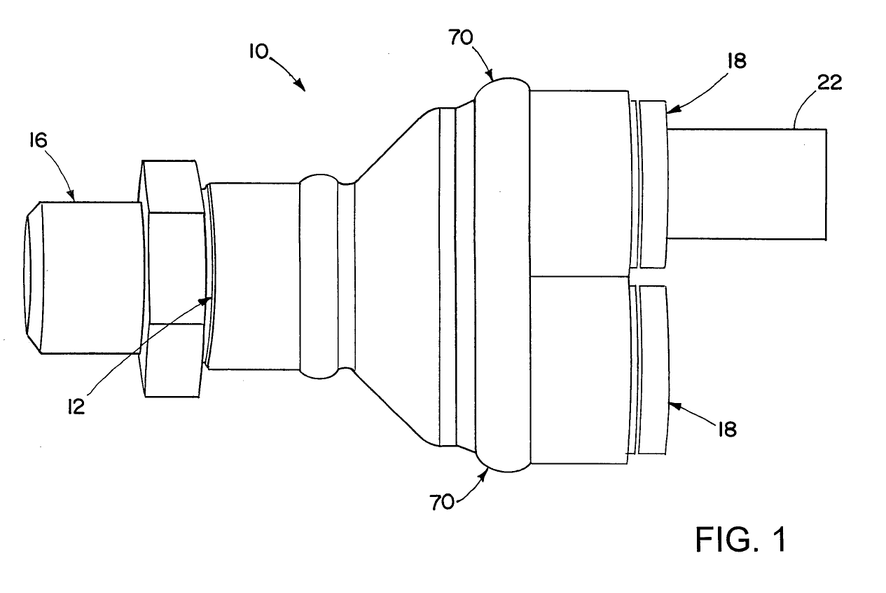

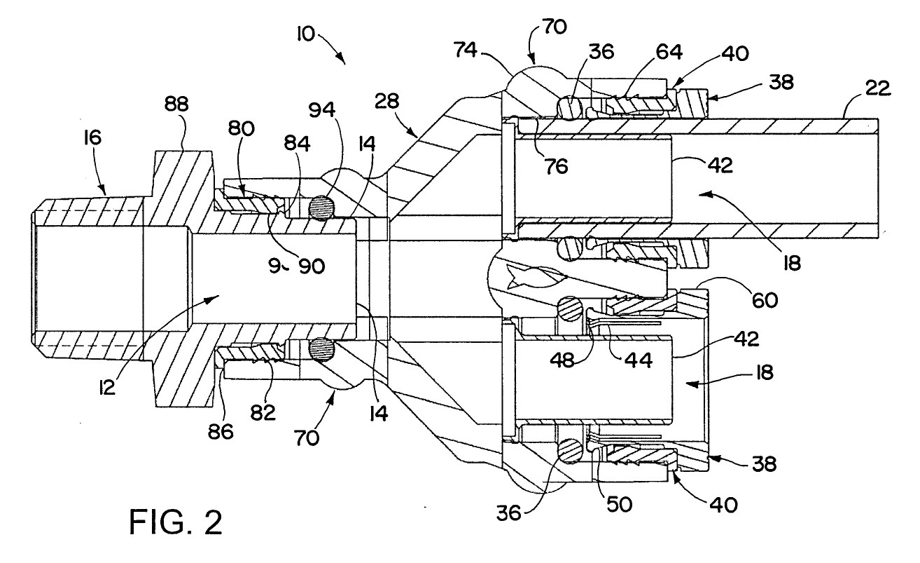

Referring now in detail to FIGS. 1 and 2, an exemplary push-in tube coupling according to the present invention is shown at 10. The illustrated tube coupling 10 is a Y-union type coupling having at one end a coupling port 12 for receiving a tubular nipple 14 of a swivel fitting 16. The other end of the tube coupling 10 has a tube port, more particularly a pair of tube ports 18, into which a respective tube can be inserted to couple the tube to the coupling. In FIGS. 1 and 2, a tube 22 is shown inserted into one of the ports 18.

As best shown in FIG. 2, the tube coupling 10 includes a body 28 that has formed therein cavities respectively forming the coupling port 12 and tube ports 18 that are connected together by an interior chamber or passage 30 in the body. Each tube port 18 has associated therewith a seal, such as an O-ring 36, a tube holder such as a gripper in the form of a collet 38, a retainer 40 and a tube support 42. The O-ring 36, which is shown located adjacent an annular stepped surface or shoulder in the port, preferably is closely fitted within the port to provide a fluid-tight seal between the interior of the body and the exterior of tube 22 when the latter is inserted into the port.

The collet 38 and retainer 40 function to retain the tube 22 in the port 18. To this end, the collet has a plurality of circumferentially spaced apart, axially extending fingers 44 that can flex radially outwardly to allow telescopic insertion of the tube through the collet. Each finger has a radially inwardly protruding barb 48 for biting into the tube and a radially outer surface 50 that interacts with the retainer to hold the fingers in biting engagement with the tube. The radially outer surface of each finger is tapered such any force acting to push or pull the tube out of the tube coupling will cause a corresponding increase in the gripping force exerted by the fingers on the tube.

The tube support 42 extends axially within the tube 22 to resist inward deformation of the tube, as may be desirable when the tube is made of an easily deformable material. The tube support may be stepped as shown to form an end abutment for the tube, and the tube port 18 may be radially stepped to form a shoulder that functions as a positive insertion stop for the tube support and tube telescoped thereover. If the tube is made of a material having sufficient strength to resist the anticipated radial gripping loads acting thereon in a particular application, the tube support can be dispensed with.

The retainer 40 surrounds the collet 38 at a location between the inner axial end portions of the fingers 44 and a radially enlarged head portion 60 of the collet. The retainer may be held in the port in the coupling body by any suitable means. As shown, the outer diameter surface of the retainer is provided with annular ridges, particularly barbs 64, for biting into the interior surface of the port 18 when the retainer is pushed into the port in the coupling body. Other means that may be employed include sonic welding and adhesives, for example.

For further details of a similar type of push-in coupling, reference may be had to U.S. Pat. No. 5,584,513, which is hereby incorporated herein by reference in its entirety.

In accordance with the present invention, the illustrated push-in coupling 10 is provided with a unique means by which proper tube insertion can be verified. In particular, there is provided a sight lens 70 that may be formed integrally with the coupling body 28 or secured in a window in the coupling body. That is, there is provided a transparent or translucent lens 70 in a wall of the coupling body for optical enhancement of an interior portion of the cavity where tube insertion can be verified.

The entire coupling body 28 may be formed, as by molding, from a translucent or transparent material, particularly a plastic material. Exemplary plastic materials include polycarbonates, polysulphones and polyetherimides. In such case the lens 70 is formed by shaping inner and/or outer surfaces of the coupling body. In the illustrated embodiment, the lens is formed by a region of the coupling body wall that has outer and inner surfaces 74 and 76, at least one of which is curved to optically magnify the interior portion of the cavity where tube insertion can be verified. More particularly, the outer surface 74 of the lens may be convex and have a radius of curvature greater than the inner surface 76 of the lens, which may be nothing more than a segment of the interior cylindrical surface of the port cavity in the coupling body. The convex lens surface 74, by way of example, may be spherical, multi-faceted, and/or it may extend circumferentially as shown.

In another embodiment, the lens 70 may be a sight lens formed separate from the coupling body 28, and then assembled in a window in the coupling body. This may be effected, for example, by molding the coupling body to the sight lens or molding the sight lens in a window opening in the wall of the coupling body, whereby an integral union is formed between the sight lens and the coupling body to prevent any leakage therebetween. In these alternative arrangements the sight lens may be formed of a transparent or translucent material, and the balance of the coupling body may be formed of a different material that need not be transparent or translucent.

The lens 70 is located in the coupling body such that the end of the tube 22 will be visible through the lens when the tube has been sufficiently inserted, such as fully inserted, into the coupling body. The magnification effected by the lens will greatly facilitate such viewing of the tube end.

As will be appreciated, the tube support 42 may be viewable through the lens when the tube is not inserted in the coupling body. If desired, the outer surface of the tube support and the outer surface of the tube may have contrasting optical properties when viewed through the lens. For instance, the tube may be black and the tube support may be white. This will assist in verifying proper insertion of the tube into the coupling body since the view through the lens will go from white to black upon insertion of the tube into the coupling body.

The above-mentioned coupling port 12 may be used, if desired, as a tube port whereby the illustrated coupler will function as a union for three tubes. For this reason, the coupling port 12 may have a magnifying lens 70 associated therewith.

Further in regard to the swivel fitting 16 (or other fitting or component including a nipple similar to that shown), the nipple 14 has telescoped thereover a tubular retainer 80 that secures the nipple in the port 12 while (optionally) allowing turning of the nipple relative to the coupling body 28. The retainer, which may be the same as the retainer 40, may be held in the port 12 in the coupling body by any suitable means. As shown, the outer diameter surface of the retainer is provided with annular ridges, particularly barbs 82, for biting into the interior surface of the port 12 when the retainer is pushed into the port 12 in the coupling body. Other means that may be employed include sonic welding and adhesives, for example.

The retainer 80 holds the nipple 14 in the coupling body 28 by engaging a radially outwardly extending shoulder 84 on the outer surface of the nipple. The shoulder 84 may be formed, for example, by an annular ridge. The axially outer side of the ridge preferably is perpendicular to the axis of the nipple, while the axially inner side may be tapered to facilitate assembly of a retainer. In the illustrated embodiment, the retainer is telescopically slipped onto the nipple and forced over the ridge, the retainer being made of any suitable material having sufficient resiliency to allow for such passage over the annular ridge, which annular ridge may also resiliently yield radially inwardly.

The retainer 80 may further have at its axially outer end a radially outwardly protruding flange 86 that limits the extent of insertion of the retainer into the port 12 by engaging an axial end face of the coupling body 28. The flange 86 may also be interposed between an axial end of the coupling body and an annular flange 88 on the swivel fitting, whereby it further serves the function of an axial bearing surface. The retainer may also have at its inner diameter surface an annular land surface 90 for engaging the outer diameter surface of the nipple 14. The land surface 90 extends less than the full axial length of the retainer and preferably is aligned radially with the annular barbs 82. It is the land that preferably has an axially inner end face that engages the shoulder 84 on the nipple. Also, the land bearing against the nipple will provide a relatively rigid radial backing ensuring secure engagement between the annular barbs and inner surface of the port 12.

As further shown in FIG. 2, the nipple 14 may be sealed to the coupling body 28 by an annular seal such as an O-ring 94.

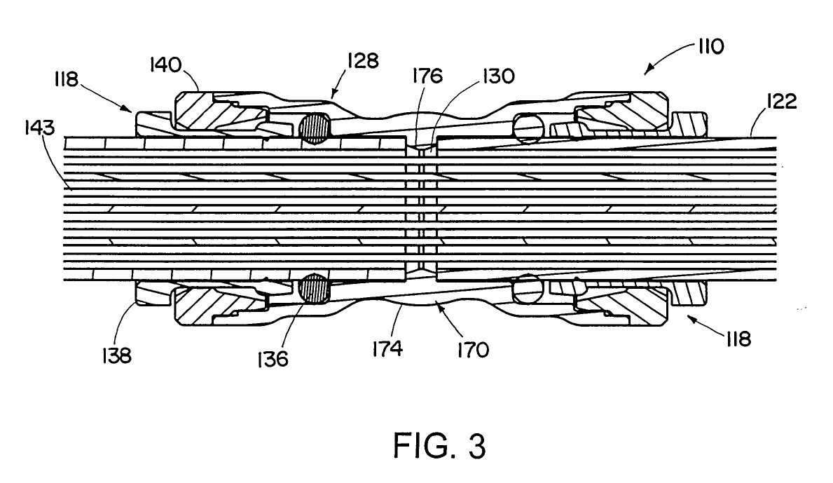

Referring now in detail to FIG. 3, another embodiment of tube coupling according to the present invention is shown at 110. The illustrated tube coupling 110 has opposite axial end portions including respective inline tube ports 118 into which respective tubes can be inserted to couple the tubes to the coupling, as shown. The tube coupling 110 includes a body 128 that has formed therein cavities respectively forming the tube ports 118 and which are connected together by an inline interior chamber or passage 130 in an intermediate portion of the body. Each tube port 118 has associated therewith a seal, such as an O-ring 136, a tube holder such as a gripper in the form of a collet 138, and a retainer 140. The O-ring 136, which is shown located adjacent an annular stepped surface or shoulder in the port, preferably is closely fitted within the port to provide a fluid-tight seal between the interior of the body and the exterior of tube 122 when the latter is inserted into the port. The collet 138 and retainer 140 function to retain the tube 122 in the port 118. The retainer 140 may be held in the port in the coupling body by any suitable means.

The tubes 122 function as protective sheaths for a bundle of optical fibers 143 that extend through the fibers and also the coupling 110. The ends of the tubes engage respective shoulders formed by an annular band protruding radially inwardly with respect to the cylindrical wall of the cavities that receive the tubes. Consequently, the above-mentioned chamber is located between the ends of the tubes and the optical fibers are exposed in the region of the chamber.

In accordance with the present invention, the coupling 110 is provided with a unique means for inspecting the optical fibers within the coupling, for example to ensure the optical fibers extend through the coupling. In particular, there is provided a sight lens 170 that may be formed integrally with the coupling body 128 or secured in a window in the coupling body. That is, there is provided a transparent or translucent lens 170 in a wall of the coupling body for optical enhancement of an interior portion of the coupling, in particular the chamber where the optical fibers are exposed.

Like the coupling body 28, the entire coupling body 128 may be formed, as by molding, from a translucent or transparent material, particularly a plastic material. Exemplary plastic materials include polycarbonates, polysulphones and polyetherimides. In such case the lens 170 is formed by shaping inner and/or outer surfaces of the coupling body. In the illustrated embodiment, the lens is formed by a region of the coupling body wall that has outer and inner surfaces 174 and 176, at least one of which is curved to optically magnify the interior portion of the cavity where tube insertion can be verified. More particularly, the outer surface 174 of the lens may be convex and have a radius of curvature greater than the inner surface 176 of the lens, which may have a negative radius of curvature, such as radially inwardly convex as shown. The convex lens surface 174, by way of example, may be spherical, multi-faceted, and/or it may extend circumferentially as shown. The lens extending annularly around the coupling body provides for viewing from any side of the coupling body.

In another embodiment, the lens 170 may be a sight lens formed separate from the coupling body 128, and then assembled in a window in the coupling body. This may be effected as above described in connection with the coupling body 28. In these alternative arrangements the sight lens may be formed of a transparent or translucent material, and the balance of the coupling body may be formed of a different material that need not be transparent or translucent.

The lens 170 is located in the coupling body such that the optical fibers between the ends of the tubes 122 will be visible through the lens. The magnification effected by the lens will greatly facilitate such viewing of the optical fibers.

Although the coupling 110 is shown in a fiber optic cable application, the coupling may be used to view other types of media, such as electrical wires, fluids, etc.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A tube coupling comprising coupling body having a cavity into which a tube can be inserted to mate with the coupling body, and a transparent or translucent lens in a wall of the coupling body for optical enhancement of an interior portion of the coupling body.

2. A tube coupling as set forth in claim 1, wherein the lens has outer and inner surfaces, at least one of which is curved to optically magnify the interior portion of the coupling body.

3. A tube coupling as set forth in claim 2, wherein the outer surface of the lens is convex and has a radius of curvature greater than the inner surface of the lens.

4. A tube coupling as set forth in claim 1, wherein the coupling body is made of a transparent material that has a portion thereof shaped to form the lens.

5. A tube coupling as set forth in claim 1, wherein the lens is secured in an opening in the wall of the coupling body.

6. A tube coupling as set forth in claim 5, wherein the wall of the coupling body is molded to the lens to form an integral union therebetween.

7. A tube coupling as set forth in claim 1, further comprising a tube holder for securing the tube in the tube body upon insertion of the tube into the tube body.

8. A tube coupling as set forth in claim 7, wherein the tube holder is a collet with radially movable fingers for gripping the tube upon insertion into the tube body.

9. A tube coupling as set forth in claim 1, further comprising a tube support within the cavity, the tube support having a tubular support portion that defines with the tube body an annular space into which the tube can be inserted and telescoped over the tubular support portion.

10. A tube coupling as set forth in claim 9, wherein the tubular support portion is viewable through the lens when the tube is not inserted in the tube body.

11. A tube coupling as set forth in claim 10, in combination with the tube, wherein the tubular support portion and tube have contrasting optical properties when viewed through the lens.

12. A tube coupling as set forth in claim 10, wherein the tube support has an abutment surface at an inner end of the tubular support portion, the abutment surface extending radially outwardly of the tubular support portion whereby it will be engaged by the end of the tube when the tube is inserted into the tube body, thereby providing an axial end stop for the tube.

13. A tube coupling as set forth in claim 1, in combination with the tube.

14. A tube coupling as set forth in claim 1, further comprising an annular seal in the coupling body, the annular seal being configured to seal against the outside surface of the tube when inserted into the coupling body.

15. A tube coupling as set forth in claim 1, wherein the lens is positioned to view an inner portion of the cavity where tube insertion can be verified.

16. A tube coupling as set forth in claim 1, wherein the coupling body has a chamber connected to the cavity, and the lens is positioned to view the interior of the chamber.

17. A tube coupling as set forth in claim 16, wherein the coupling body has opposite end portions each including a said cavity into which a respective tube can be inserted to mate with the coupling body, and an intermediate portion extending between the end portions, the intermediate portion including a chamber extending axially between the cavities and a wall including the lens.
